(19) United States
(12) Patent Application Publication
(10) Pub. No.: US 2022/0055224 A1
(43) Pub. Date: Feb. 24, 2022

(54) Configurable and Interactive Robotic Systems

(71) Applicant: DMAI, Inc., Los Angeles, CA (US)

(72) Inventors: Peter MICHAELIAN, San Francisco, CA (US); Thomas P. MOTT, Culver City, CA (US); Yixin CHEN, Los Angeles, CA (US); Hangxin LIU, Los Angeles, CA (US)

(21) Appl. No.: 17/291,154

(22) PCT Filed: Nov. 5, 2019
(86) PCT No.: PCT/US2019/059841

§ 371 Date: May 4, 2021

Related U.S. Application Data
(60) Provisional application No. 62/755,963, filed on Nov. 5, 2018.

(51) Int. Cl. B25J 11/00; B25J 9/00; B25J 9/16; B25J 19/02

(52) U.S. Cl. CPC B25J 11/0015; B25J 11/001; B25J 19/023; B25J 9/0009; B25J 9/161; B25J 9/0003

(57) ABSTRACT

A robotic system comprising: an input sensor; an electromechanical interface; an electronic interface; and a processor comprising hardware and configured to execute machine-readable instructions including artificial intelligence-based instructions, wherein upon execution of the machine-readable instructions, the processor is configured to: process an input provided by a user via the input sensor based on the artificial intelligence-based instructions; generate a first output signal that is provided to the electromechanical interface such that a movable component connected to the robotic system is put in motion, and generate a second output signal that is provided to the electronic interface such that a behavior or expression responsive to the input is rendered at the electronic interface.

### CROSS REFERENCE TO RELATED APPLICATION

This application claims priority to provisional Patent Application No. 62/755,963, filed Nov. 5, 2018, which is herein incorporated by reference in its entirety.

### FIELD

The present disclosure relates to the field of robotics, e.g., robotic systems, devices and techniques that are configurable according to user preferences, responsive to various sensor inputs and interactive with a user.

### SUMMARY

It is an aspect of this disclosure to provide a robotic system having: an input sensor; an electromechanical interface; an electronic interface; and a processor comprising hardware and configured to execute machine-readable instructions including artificial intelligence-based instructions. Upon execution of the machine-readable instructions, the processor is configured to: process an input provided by a user via the input sensor based on the artificial intelligence-based instructions; generate a first output signal, responsive to the input, that is provided to the electromechanical interface such that at least one movable component connected to the robotic system is put in motion, and generate a second output signal that is provided to the electronic interface such that a behavior or expression responsive to the input is rendered at the electronic interface.

Another aspect provides a method for interacting with a robotic system. The robotic system may include the system features noted above, for example. The method includes: using the processor to execute the machine-readable instructions; processing, via the processor, an input provided by a user via the input sensor based on the artificial intelligence-based instructions; generating a first output signal, responsive to the input, via the processor; providing the first output signal from the processor to the electromechanical interface such that at least one movable component connected to the robotic system is put in motion; generating a second output signal, responsive to the input, via the processor; and providing the second output signal from the processor to the electronic interface such that a behavior or expression responsive to the input is rendered at the electronic interface.

Other aspects, features, and advantages of the present disclosure will become apparent from the following detailed description, the accompanying drawings, and the appended claims.

### BRIEF DESCRIPTION OF THE DRAWINGS

FIGS. 1A and 1B show side and front views, respectively, of a robotic device in accordance with an embodiment of the disclosure.

FIGS. 2A and 2B illustrates examples of a user interacting with the robotic device.

FIGS. 3A, 3B, and 3C show perspective, front, and side views, respectively, of the robotic device.

FIGS. 4A and 4B illustrates front perspective views of a robotic device in a first position in accordance with another embodiment of this disclosure.

FIGS. 5A and 5B illustrates side and perspective views, respectively, of the robotic device of FIGS. 4A and 4B in a second position in accordance with an embodiment.

FIG. 6 illustrates yet another embodiment of a robotic device according to this disclosure.

FIG. 7 illustrates exemplary dimensions of the robotic device in FIGS. 4A-5B, in accordance with an embodiment.

FIG. 8 depicts an exemplary schematic diagram of parts of the robotic device and system as disclosed herein.

### DETAILED DESCRIPTION OF THE PREFERRED EMBODIMENT(S)

The robotic systems and techniques described herein provide human companionship in terms of an interactive user interface driven by specific computer-based artificial intelligence (AI) algorithms, which are implemented using appropriate hardware and software. As such, the systems and techniques described herein are necessarily rooted in technology, e.g., robotic technology.

In some embodiments, the systems and devices disclosed herein are intended to be an interactive learning assistant for children. For example, a device according to one embodiment of the disclosure may function as a desktop/tabletop product that leverages artificial intelligence to assist children and/or adults through different activities. The device may include or be connected to one or more user interfaces which render human-like animated expressions and behavior, which allows it to provide natural assistance and interaction with the user to increase adoption and learning. The child/human inputs to, and the animated outputs provided through interactive user interface(s) provided by, the device may be through one or more different modes, e.g., visual, audio, touch, haptic, and/or other sensory modes. Examples of the human-robotic device interactions include reading books, assisting with physical/written homework, interacting through learning applications on tablets/mobile devices, having natural conversation with people (voice and gesture). In accordance with an embodiment, details and features of the automated companion as disclosed in U.S. application Ser. No. 16/233,879, filed Dec. 27, 2018, which is hereby incorporated by reference in its entirety, may be included in and/or as part of the systems and/or devices provided by this disclosure.

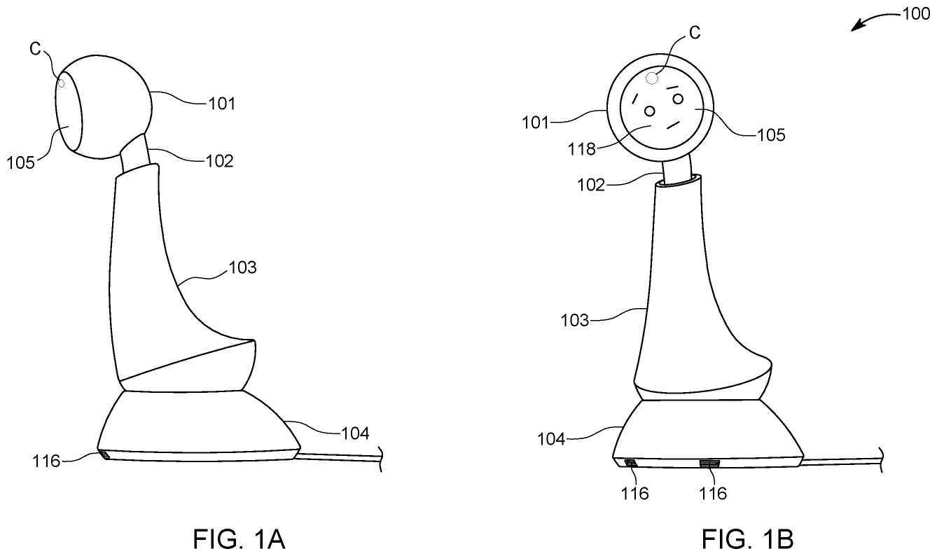

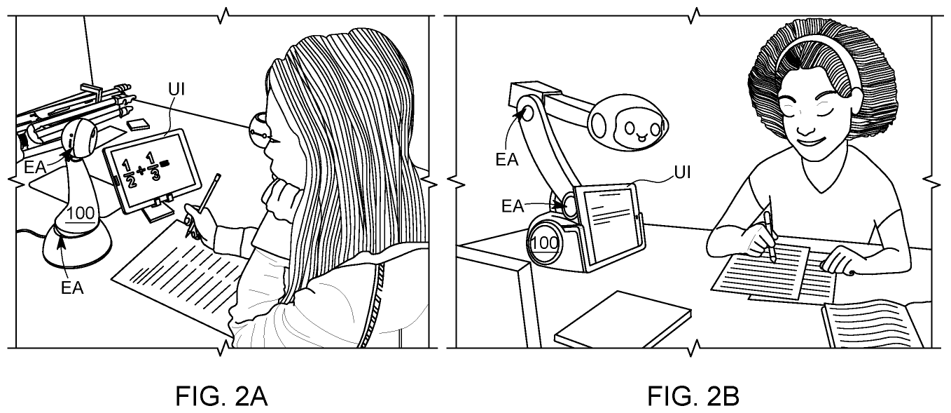

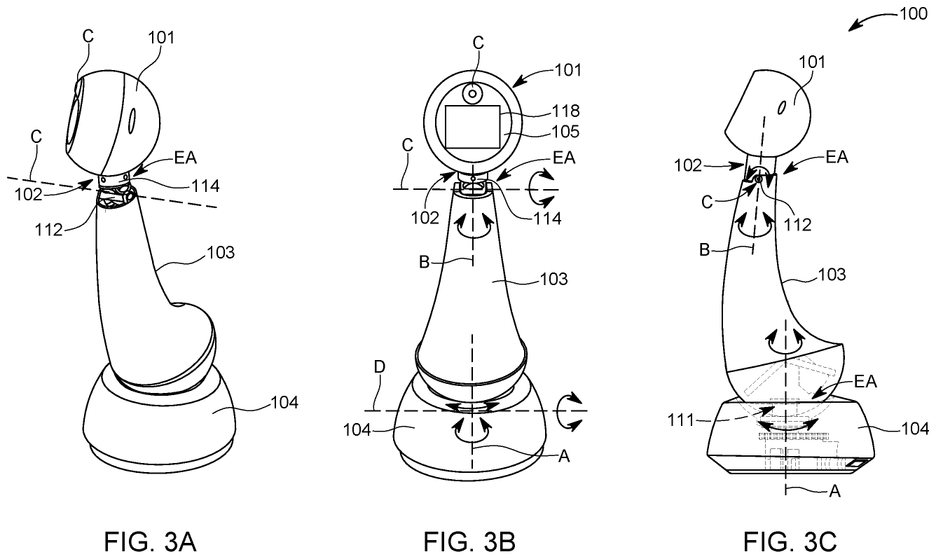

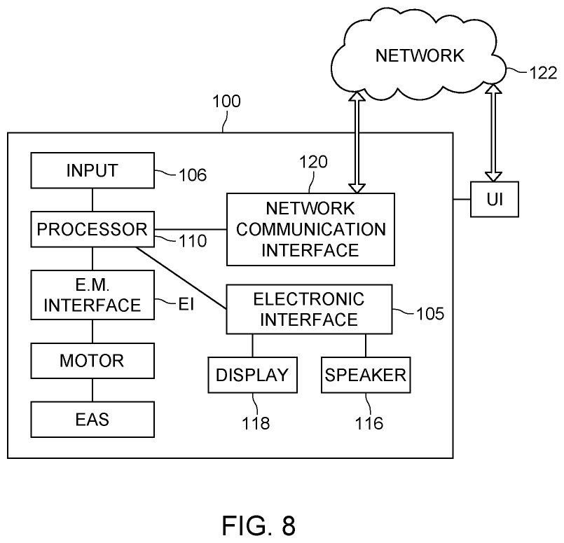

In some embodiments, the robotic system or device is implemented as a desktop electronic device capable of receiving and processing various inputs and providing outputs in accordance with computer-based instructions implemented therein. Examples of such robotic systems or devices 100 are shown in FIGS. 1A-3C and schematically in FIG. 8. The device 100 is capable of facilitating and/or assisting in interactions with a user via the device 100 and/or a user interface. In doing so, the device may be configured as an animatronic device and/or a robot device capable of controlling at least some of its parts for, e.g., making certain physical movement (such as head), exhibiting certain facial expression (such as curved eyes for a smile) on an associated display, and/or saying things (via output to speakers) in a certain voice or tone (such as exciting tones) to display certain emotions. The exemplary system/device 100 shown in FIGS. 1A, 1B (and similar devices shown in FIGS. 2A, 2B, 3A-3C) may be composed of different modular components connected to form a full body of the device 100, and or the device 100 may be unibody structure. The device 100 may have identifiable components on its outer body including head 101, neck 102, torso 103, base 104, and face interface 105. One or more of these components may be made of plastic or other synthetic material, or made of one or more metals or alloys, e.g., aluminum, and may be configured such that they can house electrical and electronic components therein in a waterproof or weatherproof arrangement. The device 100 may be configured to operate on AC supplied by an AC mains (120V) and/or DC power from a battery connected to or within the device 100.

The device 100 may be configured to provide one or multiple movable components as part of its structure. In an embodiment, the moveable components are implemented via one or more electromechanical articulations EA (or articulation joints/points) at different points on its structure, e.g., at four (4) locations. The electromechanical articulations EA are configured to allow rotation and/or pivoting of structural components, for example. The electromechanical articulations EA may be controlled via an electromechanical interface EI. The electromechanical interface EI is configured to receive a first output signal that is generated by a processor 110 and process that signal such that one or more movable components (e.g., via electromechanical articulation joints or points) connected to the robotic system is/are put in motion. In an embodiment, the electromechanical interface EI, the electronic interface 105, and the processor 110 are part of a robotic device, and the robotic device comprises a base 104 and a body 103. For example, a lower articulation of device 100 may rotate its body 103 via at least one joint 111 about a longitudinal or vertical axis A (see FIG. 3B or FIG. 3C) within a concealed base 104 and may pivot (e.g., back, forth, left, right, front, back) its body 103 via a pivot point or pivot joint, about a pivot axis D and relative to base 104, that sits above and/or in the base 104. The base 104 conceals the lower articulation points (see FIG. 3C) that allow the body 103 of the device 100 to pivot relative to the base 104, e.g., down to the ground plane. The lower rotational articulation joint 111 allows the device to rotate up to 360 degrees, while pivoting vertically (up and down), for example. The device 100 may also include an upper neck joint 112 (see FIG. 3A or FIG. 3C) at neck 102 that allows the head 101 to articulate, i.e., pivot vertically up and down about axis C via a pivot point and another mechanical joint 114 that allows the head 101 to swivel about axis B, which may be a substantially vertical axis or a vertical axis. The neck 102 may be connected to the head portion via at least one electromechanical articulation joint EA, wherein the neck 102 is configured to rotate about axis B relative to the body 103, pivot about a pivot point about axis C relative to the body 103, or both. In an embodiment, the body 103 is configured to both rotate about a vertical axis A relative to the base 103 and pivot about the pivot point relative to the base 104. Such movements (body, head, neck) may be in response to a (first) output signal that is provided to the electromechanical interface EI by the processor 110. In some embodiments, these articulations happen in tandem to allow for lifelike animation of the device 100. The electromechanical articulations/movement of the movable components of the device 100 may also be accompanied by human-like animations and expressions displayed on a display panel 118/screen (e.g., made of LCD, LED, etc.) of interface 105 (see, e.g., FIG. 1B).

The movement of the moveable components of the structure and thus the electromechanical articulations EA may be activated using motors (see FIG. 8), e.g., stepper motors and/or servo motors. One or more motors may be associated with the at least one movable component/electromechanical articulations EA. During use of the system or device 100, the processor 110 is configured to activate the one or more motors to move the at least one movable component about an articulation point in response to the input (106). The electromechanical articulations EA may comprise ball joints, swivel joints, hinge joints, pivot joints, screw joints, rotational joints, revolving joints, gears, for example.

The electromechanical articulations and other outputs provided by the device 100 are generated by a control system in the device 100, where the control system is configured to receive different inputs and process them according to AI-based techniques implemented in hardware and software at the device 100. In some embodiments, the control system of the device 100 includes a main processing unit or “processor” 110 composed of a microprocessor board, which receives a multiple of signals from various input sensors 106 associated with the device 100. Input data or “input” is provided by the user to the device 100 and the input sensors 106 forward the input to the processor 110 such that the device 100 may be controlled to perform or accomplish various output responses, including, for example, movement of a movable component or EA and/or implement a behavior or an expression, e.g., to a display 118, via electronic interface 105. That is, the processor 110 is configured to process an input provided by a user via the input sensor based on artificial intelligence-based instructions, generate a first output signal, responsive to the input, that is provided to the electromechanical interface such that at least one movable component connected to the robotic system is put in motion, and generate a second output signal that is provided to the electronic interface such that a behavior or expression responsive to the input is rendered at the electronic interface. For example, the device 100 may have a fish-eye wide-lens camera CA as an input device or sensor 106 that allows it to survey its environment and identify specific people and objects in space. Based on camera input, the articulations of the device 100 animate in specific ways. In addition, based on visual input from the camera CA, the LCD/LED panel or display 118 in the face 105 acts as a face and adjusts an expression that is displayed thereon. The LCD/LED panel can also display information to the user depending on sensor input. The device 100 may include one or more microphones at the sides of the head 101 to capture auditory input—voice and environmental sound, as input sensors 106. These microphones can also be leveraged to detect spatial differences/direction in a beam forming way, which is unique in a child's educational product. The device 100 may further include downward facing speakers 116 in the front of the base 104 that provide the auditory output. In accordance with an embodiment, the behavior rendered at the electronic interface 105 and/or device 100 includes the processor 110 being configured to emit one or more sounds or verbal responses in the form of speech via speakers 116. The electronic interface 105 may be used to deliver a response in the form of a verbal response and/or behavioral response, in response to input to the processor 110. In one embodiment, the expression rendered at the electronic interface 105 includes the processor 110 being configured to exhibit a facial expression (see, e.g., FIG. 1B) via a display 118 associated with the electronic (face) interface 105. Further, the device 100 may be configured to accept accessories, which physically and digitally adapt its external facing character to change, e.g., if an accessory representing cat ears is placed on the device 100, the face and voice of the device 100 may change to render cat-like expressions and audio outputs. Such accessory-related change in the behavior of the device 100 may happen automatically upon connecting the accessory to the device 100, or may be put in effect after a user manually inputs a command such that the device 100's configuration changes according to the attached accessory. The device 100 may include a set of pre-programmed software instructions that work in conjunction with one of many pre-determined accessories.

The device 100 may include several internal sensors responsible for gathering temperature readings, voltage and current drawn, and controlling the health of the battery, e.g., for self-monitoring and diagnosis. Problems that might occur are detected by these sensors and appropriate measures are taken, which might result in a defective device being shut down and backed up. The device 100 may include a camera (CA) to capture the close surroundings, and a pan, tilt and zoom (PTZ) camera with high zoom and low light requirement. The control unit of the device 100 may be responsible for autonomously controlling the position of these cameras. The device 100 may be controlled remotely (e.g., wirelessly or with wired connections) for teleoperation of the device. The processor 110 (e.g., a microprocessor) of the control unit may receive commands from a remote device (e.g., via an application installed on a smartphone or a tablet computer) and process them to control motor controllers, the PTZ camera, and/or the display panel 118 of the face 105.

The device 100 includes a software architecture implemented therein that encompasses the human-robot interface and high-level algorithms, which aggregate data from the on-board sensors and produce information that result in different robotic movement/articulations and expressions. The main software modules of the device 100 may include a Human-Machine Interface. This component has the role of mediation between human agents and the robot device 100. All relevant sensory and telemetric data is presented, accompanied with the feed from the on-board cameras. Interaction between the human and the robot is permitted not only to directly teleoperate the robot but also to correct or improve desired behavior. The software of the device 100 may include an Application module—this component is where the higher level AI-logic processing algorithms reside. The Application module may include the device's 100 capabilities for natural language processing, face detection, image modeling, self-monitoring, and error recovery. The device 100 may include a repository for storage for all persistent data, non-persistent and processed information. The data may be organized as files in a tree-based file system available across software modules of the device 100. There may also be device drivers, which are critical to interface the sensors and actuators with the information system inside the device 100. They mediate between hardware connected replaceable devices producing raw data, and the main robotic device processing center with a data format common across modules. The device 100 may further include a service bus, which represents a common interface to process communication (services and messages) between all software modules. Further, the device 100 is fully compliant with the Robot Operating System (ROS), which is a free and open source software framework. ROS provides standard operating system services such as hardware abstraction, low-level device control, implementation of commonly used functionality, message-passing between processes, and package management. It is based on graph architecture in which processing takes place in nodes that may receive, post, and multiplex sensor control, state, planning, actuator, and other messages. It is also a provider of distributed computing development including libraries and tools for obtaining, writing, building, and running applications across multiple computers. The control system of the device 100 is configured to operate according to the ROS syntax in terms of the concept of nodes and topics for messaging.

The device 100 may be equipped with at least one processing unit 110 capable of executing machine-language instructions that implement at least part of the AI-based interactive techniques described herein. For example, the device 100 may include a user interface UI provided at the interface 105 (or electronically connected to the device 100) that can receive input and/or provide output to a user. The user interface UI can be configured to send and/or receive data to and/or from user input from input device(s), such as a keyboard, a keypad, a touch screen, a computer mouse, a track ball, a joystick, and/or other similar devices configured to receive user input from a user of the robotic device 100. The user interface UI may be associated with the input sensor(s). The user interface UI can be configured to provide output to output display devices, such as, one or more cathode ray tubes (CRTs), liquid crystal displays (LCDs), light emitting diodes (LEDs), displays using digital light processing (DLP) technology, printers, light bulbs, and/or other similar devices capable of displaying graphical, textual, and/or numerical information to a user of the device 100. The user interface module can also be configured to generate audible output(s), such as a speaker, speaker jack, audio output port, audio output device, earphones, and/or other similar devices configured to convey sound and/or audible information to a user of the device 100. The user interface module can be configured with haptic interface that can receive inputs related to a virtual tool and/or a haptic interface point (HIP), a remote device configured to be controlled by haptic interface, and/or other inputs, and provide haptic outputs such as tactile feedback, vibrations, forces, motions, and/or other touch-related outputs.

The processor 110 is configured to perform a number of steps, including processing input data provided by the user (e.g., to the device, via the input sensor 106, and/or to user interface UI) based on the artificial intelligence-based instructions. In response to said input, the processor is configured to generate a first output signal and provide it the electromechanical interface EI such that at least one movable component (via electromechanical articulations EA) connected to the robotic system is put into motion. The processor is also configured to generate a second output signal, responsive to the input and provide the second output signal to the electronic interface 105 such that a behavior or expression responsive to the input is rendered at the electronic interface 105.

Further, the device 100 may include a network-communication interface module 120 that can be configured to send and receive data (e.g., from user interface UI) over wireless interfaces and/or wired interfaces via a network 122. In embodiments, network 122 may be configured to communicate with the processor 110. In some embodiments, network 122 may correspond to a single network or a combination of different networks. Wired interface(s), if present, can comprise a wire, cable, fiber-optic link and/or similar physical connection to a data network, such as a wide area network (WAN), a local area network (LAN), one or more public data networks, such as the Internet, one or more private data networks, or any combination of such networks. Wireless interface(s) if present, can utilize an air interface, such as a ZigBee, Wi-Fi, and/or LTE, 4G, 5G interface to a data network, such as a WAN, a LAN, a cellular network, one or more public data networks (e.g., the Internet), an intranet, a Bluetooth network, one or more private data networks, or any combination of public and private data networks.

The device 100 may include one or more processors such as central processing units (CPU or CPUs), computer processors, mobile processors, digital signal processors (DSPs), GPUs, microprocessors, computer chips, and/or other processing units configured to execute machine-language instructions and process data. The processor(s) can be configured to execute computer-readable program instructions that are contained in a data storage of the device 100. The device 100 may also include data storage and/or memory such as read-only memory (ROM), random access memory (RAM), removable-disk-drive memory, hard-disk memory, magnetic-tape memory, flash memory, and/or other storage devices. The data storage can include one or more physical and/or non-transitory storage devices with at least enough combined storage capacity to contain computer-readable program instructions and any associated/related data structures. The computer-readable program instructions and any data structures contained in the data storage include computer-readable program instructions executable by the processor(s) and any storage required, respectively, to perform at least part of herein-described techniques.

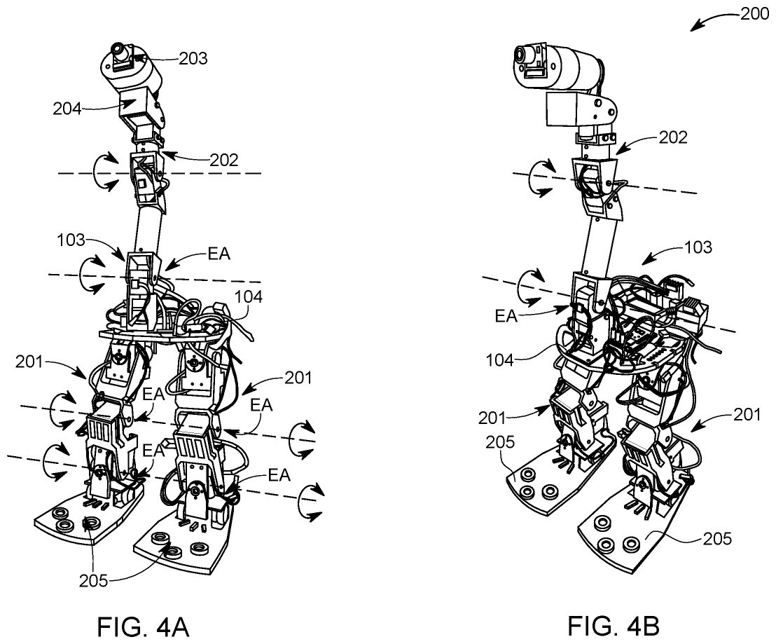

Another embodiment of the robotic systems of this disclosure includes a mobile system/device 200 depicted in FIGS. 4A-7. Although the description of FIGS. 4A-7 below may not explicitly reference the description and illustrations and features shown in FIGS. 1A-3C and 8, it should be understood that the devices illustrated and described with reference to FIGS. 4A-7 may include and/or incorporate any number of similar functional aspects and features described with reference to the aforementioned Figures (or vice versa).

For purposes of clarity and brevity, some like elements and components throughout the Figures are labeled with same designations and numbering as discussed with reference to FIGS. 1A-3C and 8. Thus, although not discussed entirely in detail herein, one of ordinary skill in the art should understand that various features associated with the device 100 of FIGS. 1A-3C and FIG. 8 are similar to those features previously discussed. Additionally, it should be understood that the features shown in each of the individual figures is not meant to be limited solely to the illustrated embodiments. That is, the features described throughout this disclosure may be interchanged and/or used with other embodiments than those they are shown and/or described with reference to.

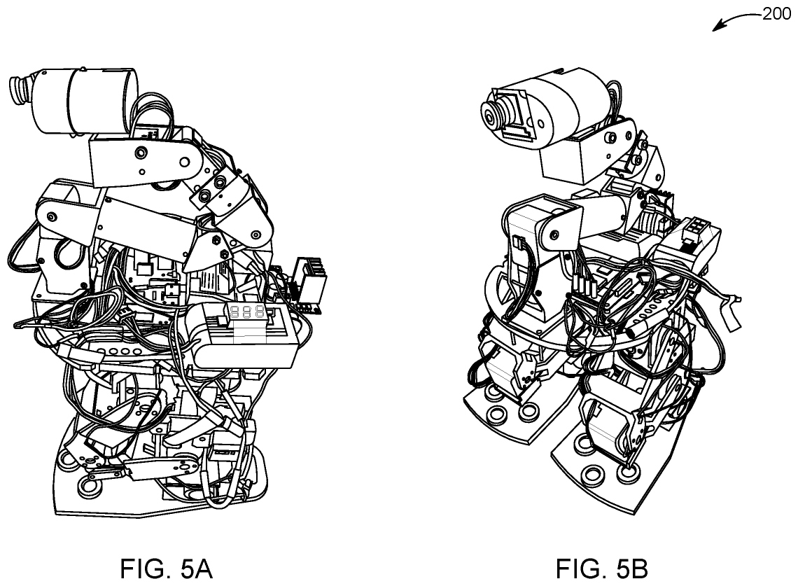

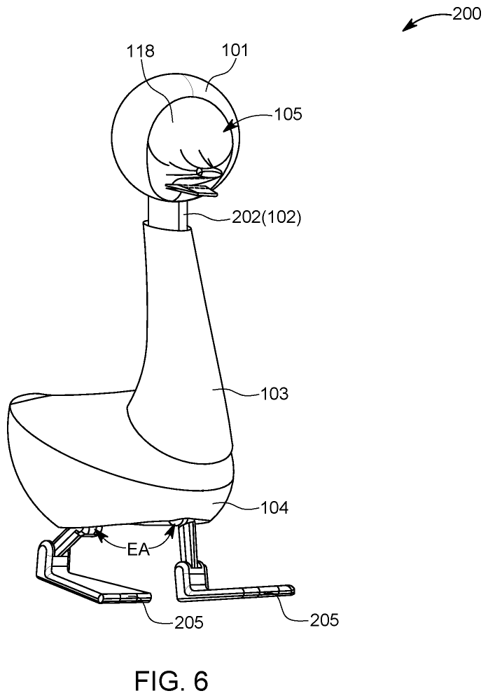

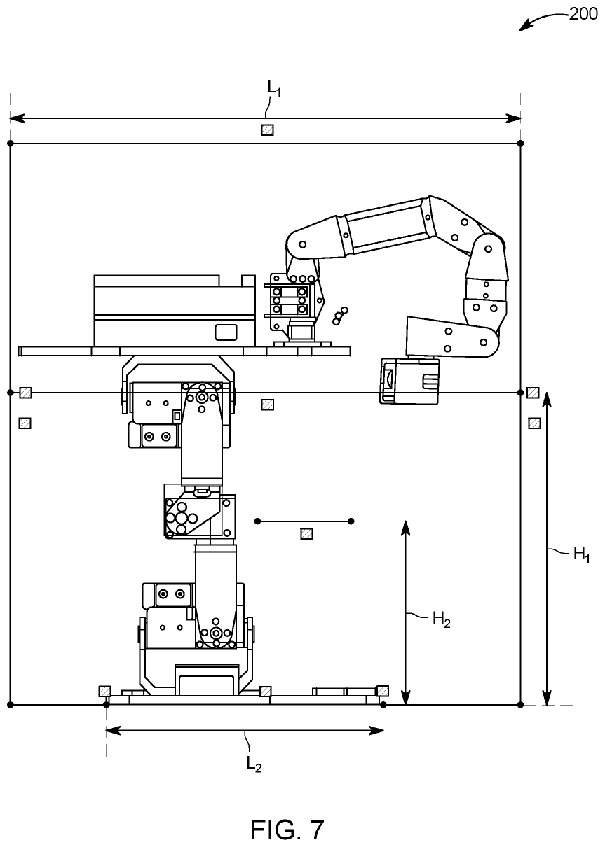

FIGS. 4A and 4B show robotic device 200 in a first position, e.g., in an extended position. FIGS. 5A and 5B show the robotic device 200 of FIGS. 4A and 4B in a second position, e.g., collapsed or nested position, in accordance with an embodiment. FIG. 6 shows one embodiment of the robotic device 200 or system. FIG. 7 shows exemplary non-limiting dimensions of the device 200.

The device 200 of FIGS. 4A-7 includes the hardware and software components of the device 100 described above, and additionally includes structural configurations and components (e.g., pedals, wheels, etc.) that allow for the movement of the device 200. In an embodiment, legs 201 and articulating feet 205 may be connected to the base 104, wherein at least the legs 201 are configured to move between a first, extended position (see FIGS. 4A, 4B) and a second, nested position (see FIGS. 5A, 5B) via electromechanical articulation joints EA, in response to the first output signal that is provided to the electromechanical interface EI (via processor 110). In some embodiments, the device 200 is a bi-pedal robot that can step over objects by articulating its feet 205, e.g., up to 5 inches and nest its legs 201 into its body in order to take on a low profile stance. The device 200 may further be configured to alternate extension and nesting of its legs 201 relative to the base (104), in response to the first output signal that is provided to the electromechanical interface EI (via processor 110). The device 200 may include an articulating neck 202 that may come off of and/or move relative to the main body (104) and act as a periscope to identify people, objects and environment through a camera 203 (which may be similar to camera CA, as previously described). This periscope also determines movement and directional orientation of the device 200. The periscope may include three (3) articulating joints that allows the neck 202 and the head 204 to stretch upwards but also reach down to the ground with the ability to see and pick up objects with its mouth/bill. a neck connected to the head portion via at least one electromechanical articulation joint, wherein the neck is configured to rotate about a vertical axis relative to the body, pivot about a pivot point relative to the body, or both, In some embodiments, global positioning of the device 200, together with its position to the ground plane and acceleration on the several axis, is gathered by an inertial measurement unit with a built-in global positioning system (GPS) device. A laser unit, mounted on a servo drive, is used for spatial awareness and obstacle avoidance. For short range obstacle detection, the device 200 has a ring of ultrasonic sensors covering the periphery of the robot.

FIG. 6 shows one example of the robotic system 200 or device in the form of a goose, with a head (like head 101), neck (like 102 or 202), body (like body 103) and base 104. Feet 205 are connected via electromechanical articulation joints EA to parts within base 104 that are generally concealed. The base 104 may also conceal lower articulation points that allow the body 103 of the device 100 to pivot relative to the body 104. Such joints may allow the body 103 of the device 200 to rotate up to 360 degrees, for example. Although the device 200 as illustrated in FIG. 6 appears to be a goose or duck, it may also be constructed in other forms as well, such as other animals including a bear, a rabbit, etc., or a person or character. In some embodiments, the face 105 on the device 200 may allow rendering of a face, expressions, or physical features (e.g., nose, eyes) of a person or an animal. Such displayed face may also be controlled to express emotion.

The body 103 of the device 200 may include parts that are stationary, movable, and/or semi-movable. Movable components may be implemented via electromechanical articulation joints EA that are provided as part of the device 200, e.g., within the body 103. The movable components may be rotated and/or pivoted and/or moved around, relative to, and/or on a surface such as table surface or floor. Such a movable body may include parts that can be kinematically controlled to make physical moves. For example, the device 200 may include feet 205 or wheels (not shown) which can be controlled to move in space when needed. In some embodiments, the body of device 200 may be semi-movable, i.e., some part(s) is/are movable and some are not. For example, a neck, tail or mouth on the body of device 200 with a goose or duck appearance may be movable, but the duck (or its feet) cannot move in space.

Turning back to FIG. 7, the dimensions illustrated are exemplary. The device 200 has an overall length L1, which may be approximately 357 mm, in accordance with an embodiment. Each foot may have a length L2, which may be approximately 194 to 195 mm, in accordance with an embodiment. The device 200 also has height H1 from the bottom of the feet 205 to a top articulation joint of the legs 201, which may be approximately 218-219 mm, in accordance with an embodiment. A height H2 of the bottom portion of the legs 201 (e.g., from a knee articulation joint) may be approximately 128 mm, in accordance with an embodiment.

In some embodiments, each of many motors within the device 200 is directly coupled to its corresponding wheel or pedal through a gear. There may not be any chain or belt, which helps not only reduce energy loss but also the number of failure points. Using software and appropriate hardware, the device 200 may provide locomotion control by estimating motor position and velocity according to motion commands and based on the robot's modeled kinematics. The device 200 may also be configured for navigation that involves path planning and obstacle avoidance behaviors. By receiving and fusing sensory information, position and velocity estimates, the device 200 may be able to determine a path to the desired goal as well as the next angular and linear velocities for locomotion control.

As such it can be seen by the description and associated drawings that one aspect of this disclosure provides a robotic system having: an input sensor; an electromechanical interface; an electronic interface; and a processor comprising hardware and configured to execute machine-readable instructions including artificial intelligence-based instructions. Upon execution of the machine-readable instructions, the processor is configured to: process an input provided by a user via the input sensor based on the artificial intelligence-based instructions; generate a first output signal, responsive to the input, that is provided to the electromechanical interface such that at least one movable component connected to the robotic system is put in motion, and generate a second output signal that is provided to the electronic interface such that a behavior or expression responsive to the input is rendered at the electronic interface.

Another aspect provides a method for interacting with a robotic system. The robotic system may include the system features noted above, for example. The method includes: using the processor to execute the machine-readable instructions; processing, via the processor, an input provided by a user via the input sensor based on the artificial intelligence-based instructions; generating a first output signal, responsive to the input, via the processor; providing the first output signal from the processor to the electromechanical interface such that at least one movable component connected to the robotic system is put in motion; generating a second output signal, responsive to the input, via the processor; and providing the second output signal from the processor to the electronic interface such that a behavior or expression responsive to the input is rendered at the electronic interface.

The method may further include pivoting the body about the pivot point relative to the base, in accordance with an embodiment. In an embodiment, the method may include rotating the body about the vertical axis relative to the base. The method may further include pivoting the head portion about the axis via the pivot point and swiveling the head portion, in one embodiment. In an embodiment, the method may include rotating and/or pivoting the neck relative to the body. The method may further include emitting, via the processor, one or more sounds or verbal responses in the form of speech via speakers, in accordance with an embodiment. The method may further include exhibiting, via the processor, a facial expression via a display associated with the electronic interface, in an embodiment.

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will thus be seen that the features of this disclosure have been fully and effectively accomplished. It will be realized, however, that the foregoing preferred specific embodiments have been shown and described for the purpose of illustrating the functional and structural principles of this disclosure and are subject to change without departure from such principles. Therefore, this disclosure includes all modifications encompassed within the spirit and scope of the following claims.

What is claimed is:

1. A robotic system comprising:
an input sensor;
an electromechanical interface;
an electronic interface; and
a processor comprising hardware and configured to execute machine-readable instructions including artificial intelligence-based instructions, wherein upon execution of the machine-readable instructions, the processor is configured to:
process an input provided by a user via the input sensor based on the artificial intelligence-based instructions;
generate a first output signal, responsive to the input, that is provided to the electromechanical interface such that at least one movable component connected to the robotic system is put in motion, and
generate a second output signal that is provided to the electronic interface such that a behavior or expression responsive to the input is rendered at the electronic interface.

2. The robotic system according to claim 1, wherein the at least one movable component comprises one or more electromechanical articulation joints that are configured to allow rotation about a vertical axis and/or pivot about a pivot point.

3. The robotic system according to claim 1, wherein the electromechanical interface, the electronic interface, and the processor are part of a robotic device, wherein the robotic device comprises a base and a body, wherein the body is the at least one movable component comprising a plurality of electromechanical articulation joints, wherein the body is configured to pivot about a pivot point relative to the base, in response to the first output signal that is provided to the electromechanical interface.

4. The robotic system according to claim 3, wherein the body is configured to both rotate about a vertical axis relative to the base and pivot about the pivot point relative to the base, in response to the first output signal that is provided to the electromechanical interface.

5. The robotic system according to claim 3, wherein the body comprises a head portion that is configured to pivot vertically up and down about an axis via a pivot point and another mechanical joint that allows the head portion to swivel about a substantially vertical axis or vertical axis, in response to the first output signal that is provided to the electromechanical interface.

6. The robotic system according to claim 5, further comprising a neck connected to the head portion via at least one electromechanical articulation joint, wherein the neck is configured to rotate about a vertical axis relative to the body, pivot about a pivot point relative to the body, or both, in response to the first output signal that is provided to the electromechanical interface.

7. The robotic system according to claim 3, further comprising legs and articulating feet connected to the base, wherein at least the legs are configured to move between a first, extended position and a second, nested position via electromechanical articulation joints, in response to the first output signal that is provided to the electromechanical interface.

8. The robotic system according to claim 7, wherein the robotic device is configured to act as a bi-pedal robot configured to take steps by articulating its feet and alternating extension and nesting of its legs relative to the base, in response to the first output signal that is provided to the electromechanical interface.

9. The robotic system according to claim 1, wherein the input sensor is associated with a user interface.

10. The robotic system according to claim 1, further comprising a camera to identify people, objects, and environment therethrough.

11. The robotic system according to claim 1, wherein the behavior rendered at the electronic interface comprises the processor being configured to emit one or more sounds or verbal responses in the form of speech via speakers.

12. The robotic system according to claim 1, wherein the expression rendered at the electronic interface comprises the processor being configured to exhibit a facial expression via a display associated with the electronic interface.

13. The robotic system according to claim 1, further comprising one or more motors associated with the at least one movable component, and wherein the processor is configured to activate the one or more motors to move the at least one movable component about an articulation point in response to the input.

14. A method for interacting with a robotic system, the robotic system comprising an input sensor, an electromechanical interface, an electronic interface, and a processor comprising hardware and configured to execute machine-readable instructions including artificial intelligence-based instructions; the method comprising:
using the processor to execute the machine-readable instructions;
processing, via the processor, an input provided by a user via the input sensor based on the artificial intelligence-based instructions;
generating a first output signal, responsive to the input, via the processor;
providing the first output signal from the processor to the electromechanical interface such that at least one movable component connected to the robotic system is put in motion;
generating a second output signal, responsive to the input, via the processor; and
providing the second output signal from the processor to the electronic interface such that a behavior or expression responsive to the input is rendered at the electronic interface.

15. The method according to claim 14, wherein the electromechanical interface, the electronic interface, and the processor are part of a robotic device, wherein the robotic device comprises a base and a body, wherein the body is the at least one movable component comprising a plurality of electromechanical articulation joints, wherein the body is configured to pivot about a pivot point relative to the base, in response to the first output signal that is provided to the electromechanical interface, and wherein the method further comprises pivoting the body about the pivot point relative to the base.

16. The method according to claim 15, wherein the body is configured to both rotate about a vertical axis relative to the base and pivot about the pivot point relative to the base, in response to the first output signal that is provided to the electromechanical interface, and wherein the method further comprises rotating the body about the vertical axis relative to the base.

17. The method according to claim 15, wherein the body comprises a head portion that is configured to pivot vertically up and down about an axis via a pivot point and another mechanical joint that allows the head portion to swivel about a substantially vertical axis or vertical axis, in response to the first output signal that is provided to the electromechanical interface, and wherein the method further comprises pivoting the head portion about the axis via the pivot point and swiveling the head portion.

18. The method according to claim 17, further comprising a neck connected to the head portion via at least one electromechanical articulation joint, wherein the neck is configured to rotate about a vertical axis relative to the body, pivot about a pivot point relative to the body, or both, in response to the first output signal that is provided to the electromechanical interface; and wherein the method further comprises rotating and/or pivoting the neck relative to the body.

19. The method according to claim 14, wherein the behavior rendered at the electronic interface comprises emitting, via the processor, one or more sounds or verbal responses in the form of speech via speakers.

20. The method according to claim 14, wherein the expression rendered at the electronic interface comprises exhibiting, via the processor, a facial expression via a display associated with the electronic interface.
